(19) United States
(12) Patent Application Publication
(10) Pub. No.: US 2017/0262763 A1
(43) Pub. Date: Sep. 14, 2017

(54) System for anticipating the actions of biological and natural entities

(71) Applicant: Robert Stewart Smith, Calgary (CA)

(72) Inventor: Robert Stewart Smith, Calgary (CA)

(21) Appl. No.: 15/068,613

(22) Filed: Mar. 13, 2016

(51) Int. Cl. G06N 7/00; G06F 17/30

(52) U.S. Cl. CPC G06N 7/005; G06F 17/30312

(57) ABSTRACT

A method and system for anticipating the actions of individuals and the occurrence of natural events are disclosed. The anticipatory information system (AIS) stores information using specific and unique methods and applies unique methods to evaluate and identify the upcoming actions of individuals or the upcoming occurrence of natural events based on unique analysis methods applied to existing action and event information, previous action and event stored information, information about nearby and influential actions and the application of a method for determining and ranking the likelihood of an actions occurrence and options for mitigating the resulting effect of such actions.

### BACKGROUND OF THE INVENTION

1. Field of the Invention

This invention relates to biological entity and natural action and event anticipation and its use and application in artificial intelligence systems, machine erudition and in the identification of anticipated future actions and events for the purposes of computer assisted risk mitigation and emergency response systems.

2. Description of the Related Art

The need for improved machine and deep learning has increased significantly as artificial intelligence (AI) systems seek to improve the way machines help humans. These AI systems desire to have computers make decisions at a rate faster and more accurately than the human mind but in a manner consistent with human decision making. To date, these systems have lacked a key element in the human decision making process, the ability to anticipate the actions of both human's and natural systems and the ability to adapt actions and activities based on this information. This ability is critical for rapid and accurate decision making and machine erudition which has become a critical need in systems that make life saving decisions such as self driving cars or emergency disaster response systems. Currently, AI systems use linear analysis techniques that simply view deterministic data on a continuum and react when sensor based information provides an indication of a change. Their predictive ability extends only seconds into the future and is at best a linear interpretation of a current trajectory of actions. However, the application of anticipation techniques modeled in an Anticipatory Information System (AIS) and based on how the human mind uses risk to make decisions, vastly increases the length of time into the future that accurate predictions can be made about the actions of individuals or natural occurring events and significantly reduces the amount of time needed to react to variances between anticipated actions or natural events and actual actions or natural events. This information can then be used to improve the response and reaction of AI and other systems to sensor data, large data sets and to improve machine erudition and deep learning through proprietary backpropagation methods and algorithms.

An Anticipatory Information System as described provides an improved series of methods and information to existing systems that increases the efficiency and accuracy of machine learning and analysis methods and that significantly improve existing data analysis methods especially in areas such as complex data and large data set analysis and advanced event prediction and detection. The potential use of such information could save numerous lives from accidents and disasters. Current systems do not have the capability to anticipate individual actions or natural events effectively nor the ability to use such information to adjust their analysis methods to incorporate immediate and highly accurate changes in current actions or events in response.

### SUMMARY

Various embodiments of a method and system for anticipatory action and event identification are disclosed. According to one embodiment, a method may include one or more actions or events or the combination of actions or events into a single action or event whereby an action or event is identified as an elemental combination of flow information including, but not limited to, an entity, agreements, measures and valuations, nodes, waypoints, inventories, velocity, directionality, trajectory, speed, distance, probability of occurrence, variance, georelational indication, categories, relationships, affect, relevance, relevance correlation, time, spatial indication and versioning. The method may further include completely specifying the next actions or events of an entity including, but not limited to, changes to entities, agreements, measures and valuations, nodes, waypoints, inventories, velocities, directionality, trajectory, speeds, distances, probability of occurrence, variances, georelational indications, categories, relationships, affects, relevance, relevance correlations, time, spatial indications and versions.

According to another embodiment, a method may include determining the status of an action or event as measured by, but not limited to, entities, agreements, measures and valuations, nodes, waypoints, velocities, directionality, trajectory, speeds, distances, probability of occurrence, variances, georelational indications, categories, relationships, affects, relevance, relevance correlations, time, spatial indications and versions and any variance to expected actions or events. The method may further include using variance information to determine the next available actions or events of the entity and probability of occurrence and level of risk.

A system is further contemplated that in one embodiment is a computer system configured to identify one or more series of anticipated actions or events, their probability of occurrence and the level of risk to an entity and others entities from each action or event or series of actions and events. The system will make available this information for use in other systems and for machine erudition and deep learning to improve anticipatory methods. Other systems could include emergency and disaster response systems or risk avoidance systems designed to automatically take or suggest actions to reduce risk.

### DESCRIPTION OF THE DRAWINGS

In the drawings, which form a part of this specification,

FIG. 1 is a block diagram illustrating one embodiment of an anticipatory information system configured to implementing the relationships between existing actions to determine an anticipated action or series of actions.

FIG. 2 is a block diagram illustrating one embodiment of an anticipatory system configured to implement external data to adjust the determination of an anticipated action or series of actions.

FIG. 3 is a flow diagram illustrating one embodiment of methods of determining an anticipated action for a specific target entity.

FIG. 4 is a flow diagram illustrating one embodiment of methods of determining the adjustment of an anticipated action for a specific target entity based on the outcome of an actual action (erudition).

FIG. 5 is a block diagram illustrating one embodiment of an anticipation computer system configured to host and implement an action anticipation model.

FIG. 6 is a block diagram illustrating one embodiment of an anticipatory system configured to implement a string or series of anticipated actions to determine multiple anticipated actions.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

### Overview of Anticipatory Information System

Individuals are continuously performing a series of actions throughout their day. These actions can be defined and described by a series of unique text and numerical meta data that accurately describes all the conditions and elements necessary for the human brain, and therefore systems, to determine a series of categorizations for the actions or events that can be used to uniquely identify the action or event and its relationship to subsequent actions or events. The same is true of natural systems. Both individual actions and natural events can impact the actions and life of a target entity and other entities. As well, the actions of the target entity can impact the lives or actions of other nearby entities. Specific changes in the meta data of an action taken individually or within a progression of actions (action string or action streams) can provide a very high degree of certainty of upcoming actions that will be taken by a target entity or that should be taken by a target entity to reduce risk. For example, a person standing on a corner of a street waiting to cross is an example of an action and through sensory observation, one can easily tell that it is highly likely that when a specific change in the environment occurs, such as the street light changing, that the individuals action can be anticipated to be that they will step out and cross the street. However, if the individual was to turn around and walk the other direction, that action would be different from the expected or anticipated action of the target entity. A computer device such as a smartphone or computer assisted camera, aided by Anticipation Information System methods, can detect and determine both the anticipated actions of a target entity (crossing the street) and the resulting change in actions (walking away from the street) and use this information to develop a new set of anticipated actions for the target entity. If information is presented by sensors that a natural event such as a flood of water was coming down the street toward the direction the individual was moving, an anticipatory system could send a risk notification to the individual that they needed to change their activity thereby reducing the risk of injury or loss of their life. Had the individual continued across the street, the result may not produce an indication to change an action if the anticipated direction and velocity of the flood was away from the target entity direction and velocity of travel.

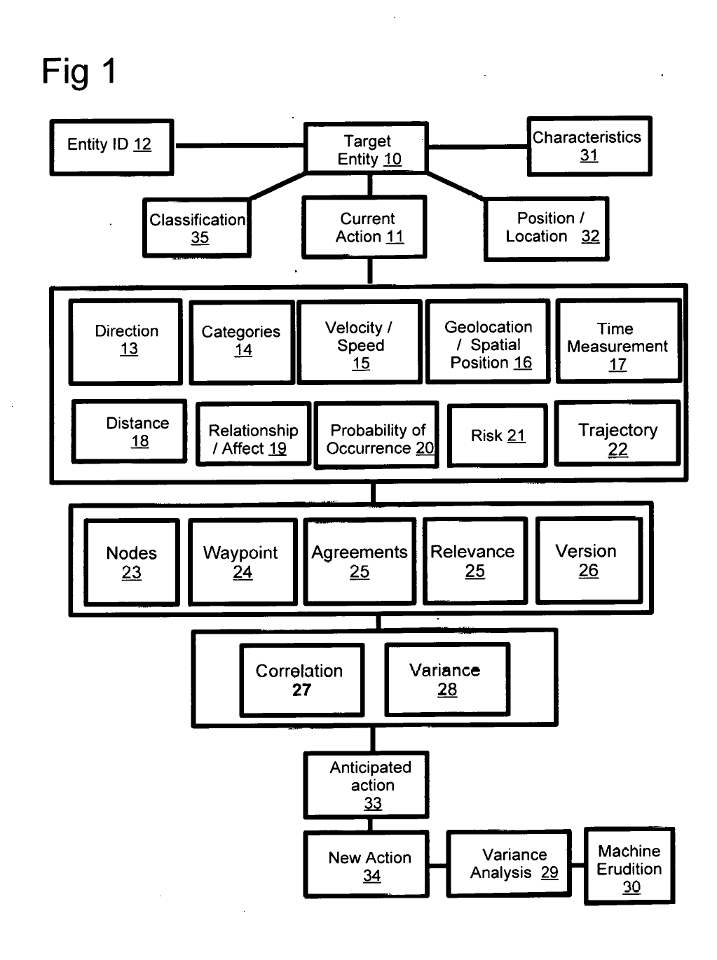

One exemplary embodiment of an anticipatory information system is illustrated in FIG. 1. In the illustrated embodiment, a target entity is identified as the focus of the anticipatory system for the purposes of determining a single anticipated action or a series of subsequent anticipated actions to be made by the target entity or required to be made by the target entity or events or anticipated actions of other entities that will negatively impact the target entity. The identity of a specific entity 10, wherein an entity is described as any individual, animal, microbe, biological or natural system and giving an existence to such entity as evidenced by meta information that identifies the entity uniquely including but not limited to, identification attributes 12, substance and form 14 position 15, physical, biological and mental characteristics 14, location 15, velocity and speed 18, spatial position 19, time 20, distance 21, relationship 22, category 17, and classification 13.

The current action of a target entity 11 measured by external input devices and sensors including but not limited to, video capture devices, sensors used to detect physical change including, but not limited to, changes in temperature, pressure, light, air flow, motion and other environmental measures, system information that the entity is near or is using or is otherwise engaged with or has been detected by and in so doing, calculates a version of an existing action that can be compared against a structured database of actions and subsequently used as a basis for the system to determine one or more next or anticipatory actions. These next or anticipatory actions 33 are created by the identification of potential actions available to the entity evaluated by the implementation of flow methods that indicate a series of scenarios, each with their own meta information that provide a set or sets of actions or flows that the entity may take. These flows or streams or strings of actions are defined through methods and algorithms that identify how a stream of actions are articulated through waypoints 27 and between nodes 26 with velocity 18, trajectory 25, directionality 16 and within a context of time 20. Agreements 28 encapsulated information elements that identify the relationship and dependency between waypoints 27 and nodes 26 further helping to define the next or anticipated actions and versioning methods 30 track and incorporate the timing of measured actions and changes between such measured actions. Risk 24 and probability methods 23 differentiate available actions and provide a method to prioritize actions based on the action's relevance information to meta information markers such as a potential terrorist event or action or the behavior of another nearby entity. Correlation 31 and variance methods 32 are used to apply change and delta information derived from the aforementioned methods and apply the change information to the existing action to define an anticipated or next action 33. When a new action is detected 34, variance methods 35 are implemented to update existing structurally stored action meta data to improve the detection capabilities of the system 30. Algorithms and structured data inclusive of digital serialization and meta tagging provides the primary methodology, but not the entirety of the methodology, for evaluating existing actions and determining the next anticipated action and subsequent action streams or strings.

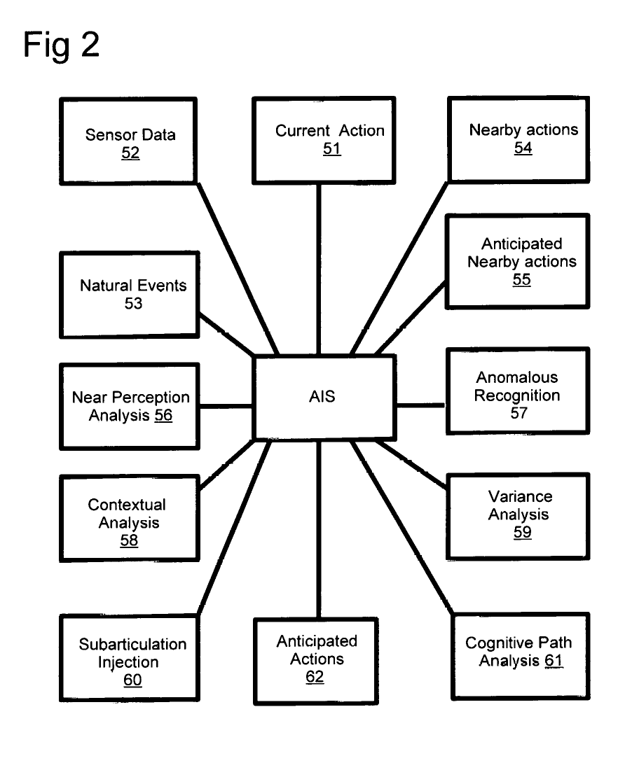

One embodiment of a system configured to determine an anticipatory action is illustrated in FIG. 2 whereby the detection and evaluation of an entities current action 51 is used as the base on which the system builds a single next anticipated action of the target entity. This action is one of a stream of actions all extending subsequently from the current action and may or may not be an action that the entity is aware it needs to do. This is because the Anticipatory Information System is simultaneously evaluating incoming sensor data 52, including data from other systems such as, but not limited to, environmental systems, video systems, computers systems in use by the individual, or databases that contain information about the individuals previous actions or the previous actions of others, AIS database stored information about the entities previous actions, or some subset of such systems as well as other systems and sensor data. The AIS simultaneously analyzes input information from sensors that monitor natural elements and other events near the current action and stored database information on the impact and resulting influence that such events would impart on the current and anticipated action 53. The AIS simultaneously evaluates the actions of other nearby entities 54 and information stored about these nearby entities activities within the AIS and other systems such as, but not limited to, environmental systems, video systems, computers systems in use by the individual, or databases that contain information about the individuals previous actions, AIS database stored information about the entities previous actions, or some subset of such systems as well as other systems and sensor data and evaluating the impact that these nearby actions and action streams, inclusive of anticipated action and anticipated action streams 55, would have on the target entities current and anticipated action and anticipated action streams.

The AIS performs a series of analyses on this information including near perception analysis 56 implementing methods that identify through inference, nearby entities and their current actions and their resulting impact and anticipated impact on the target entity's current and anticipated actions. For example a detected spray of water as seen by a video motion detection device indicates the action of a nearby entity that could impact a target entity that is painting a fence if the AIS analysis of that nearby entities action or actions is such that the behavior of the nearby entity is indicative of a sufficient threat level to the target entity's action such that the target entity should alter their current action to protect their painting through a mitigation action such as the announcement of their activities to the nearby entity or protecting their work with a cover. The AIS also performs an analysis of input data using anomalous recognition methods 57 that identify patterns of current actions by other entities that appear consistent, congruent and similar such that the actions are evaluated by the AIS to be outside the boundary's of normal consistency, congruence and similarity as stored in the AIS databases of comparable activities and that such actions are identified by the system as anomalous. Some, but not necessarily all of the anomalous recognition methods, use algorithms that identify unusual patterns of actions by comparing the output of the anomalous recognition algorithms to stored baselines measures and metrics of expected activity for specific geo or spatial locations or as it relates to clusters of data on monitored measurement and sensor systems and other systems such as but not limited to, data publicly available on the internet or data in non public systems. The AIS also implements methods for subarticulation injection 60 which store additional action and event information with specialized algorithm meta data permitting fast analysis of nearby actions 54 on natural events 53 and a determination of the impact those actions or events on a target entity's action or anticipated action or actions. Additional methods are implemented to perform contextual analysis 58 for identifying the context of input data and input data evaluation and variance analysis 59 for identifying the degree of variance between incoming and existing datasets. Contextual analysis uses methods and objects implemented by the AIS to determine the relevance of external sensor and system information using algorithms to instantiate objects with meta data or variables about actions, events and entities to produce a set of meta data of contextual relevance to the current and anticipated action or stream of actions of the target entity. Variance analysis measures the degree of change between anticipated action streams and revised action streams at waypoints in the action stream using algorithms and expected outputs stored in AIS databases. The AIS implements cognitive path analysis 61 including but not limited to cognitive bridging and cognitive differentiation methods through implementation of relevance meta data identified in input data streams from sensors, other systems or AIS algorithms, methods, objects or databases to instantiate cognition analysis objects. Pattern determination methods identify relevance results that are within defined boundaries similar to the methods implemented in anomalous recognition. The resulting output of the system is a single anticipated action of a target entity and a series of additional actions forming an action stream (or action string) of a target entity most likely to occur 63. The meta data of the anticipated action can then be implemented by other systems to perform a variety of functions including but not limited to, notification of an impending action or actions, determination of the results of an impending action or actions, the initiation of mitigation systems or the prompting of mitigation actions by others.

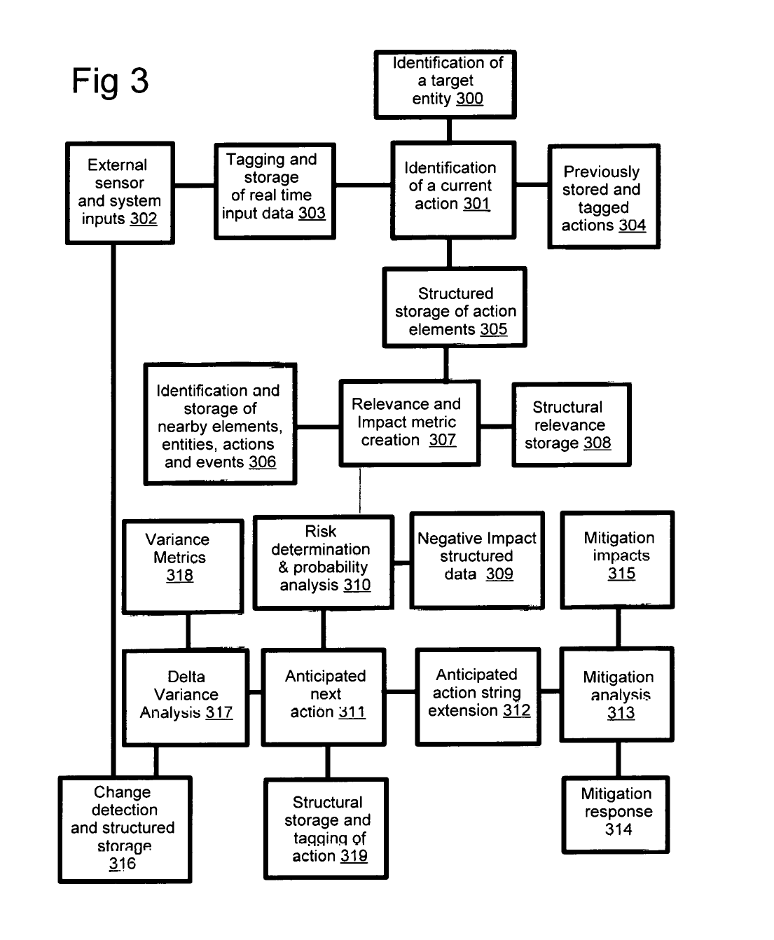

In one embodiment, shown in FIG. 3, an entity 300 is identified by various meta data and analysis methods as a target entity. Systems and sensors around the entity receive, create and send information to the AIS and the AIS uses the information by comparing it to a database of activities 304 to identify a current activity 301 or matrix or array of current activities (one or more activities conducted simultaneously or consecutively). The AIS updates the meta information from the matching stored activities with information from sensors and systems to form a baseline activity (i.e. target entity watching 1 V in his home while eating food). Input data from sensors and other systems 302 is improved with algorithms 303 to append additional meta data for in-stream data analysis (real time analysis by the AIS of received information), storage and subsequent analysis. Baseline meta data once improved is stored in the form of action elements, metrics, variables and digital serialization values 305 that are later used by the AIS in evaluating such factors as relevance. Action elements include the individual actions within an action matrix (such as movement, selecting a new channel, or stopping eating). The AIS implements digital serialization (numeric representation) to store multiple indices of information in numerical keys that can provide one or more indices through algorithmic calculation and factoring for use in obtaining information from one or more databases. Digital serialization forms the structural database storage mechanism used by the AIS data warehouse to uniquely store and retrieve information for the purposes of determining an anticipated action or action string of a target entity.

The AIS simultaneously analyses nearby actions and action elements and natural events 306 for structured storage (storage with additional meta information) into a database and uses this information along with a database of relevance information 308 to determine the impact that an external action or actions are having or will have on the target entity's current actions and to create relevance metrics 307 used by the AIS to determine the anticipated action of the target entity. Such actions can include the action an entity should take to mitigate the effect of other nearby actions as well as natural events or the actions that are anticipated to be taken by the entity or other nearby entities or natural events. The AIS performs a risk and probability analysis 310 implementing methods that match the action against a databases of negative impacts 309 and algorithms that evaluate the level of risk based on flow principles previously described including but not exclusively limited to, velocity, trajectory, directionality, speed, position, perceived intent and a context of time. The AIS determines the next anticipated action 311 of the target entity and subsequent actions forming a string or stream of actions 312 and performs a mitigation analysis 313 using a database of mitigation impact 315 and provides a mitigation response 314 based on the anticipated action and the analysis of other nearby actions, action elements and events and input from a database of mitigation responses. Each change in input information 316 results in a delta variance analysis 317 that is used to determine the measure of impact of the data change on the anticipated action by implementing analysis methods and a database of variance metrics 318 and if the change is outside the limits set in a variance database, to re-instantiate the anticipatory objects. All anticipated action meta data and resultant actual detected action data is stored using algorithms and structured data methods for subsequent AIS analysis 319.

In some embodiments, the AIS system calculates unique linkages between actions forming action streams or action strings that are a series of sequential actions anticipated to be taken by the target entity or nearby entities. The strings are multi-dimensional in that actions that are subsequent to a current action may result in more than one option at each waypoint in the action stream. A car driving down a road can be expected to continue driving down the road unless something happens that would cause the driver to veer off course. The next anticipated action would be similar to the current action with changes in meta data including but not limited to time, spatial position, location, velocity and trajectory. Should input sensors alert the AIS to a landslide ahead of a car driving down a road inclusive of size, speed and location of the landslide and the AIS determines that the trajectory of the slide intersects with the path of the car and that the likelihood of this occurrence is high, then the AIS can alert the driver of the car, inclusive of mitigation options, or can automatically alter the path of the car thereby changing the entire version or versions of the entities action stream or action string. This change becomes the immediate baseline for the next new anticipated action and action stream. If a sensor detects a truck approaching from behind the car at a high rate of speed and a road sensor indicates the presence of ice, the AIS can alter the anticipated action of the entity and the vehicle to instead of one of hard braking, to be one of slowing down to avoid both the rock slide in front of the vehicle and the anticipated sliding truck behind the vehicle. The ability of the AIS to identify subsequent anticipated events and actions and provide information to change the action or result of the action is indicative of the systems capacity to link subsequent actions together into multiple stream options and then immediately adjust them as new information is received by adjusting the next anticipated action and all subsequent linked actions. What permits this to occur is the unique methods invoked to analyze and process stored data using algorithms unique to the purpose of defining anticipatory actions and the storing of information used in this process. The uniqueness of the system comes from its anticipatory capability by implementing proprietary methods and data structures and in its ability to reassemble input information strictly for the purposes of anticipating human action before such action is contemplated by the target entity and to implement the use of such information in the identification and analysis of actions and action strings indicative of potential threats to the target entity and to identify harm avoidance actions and to provide such indications to the target entity or other systems.

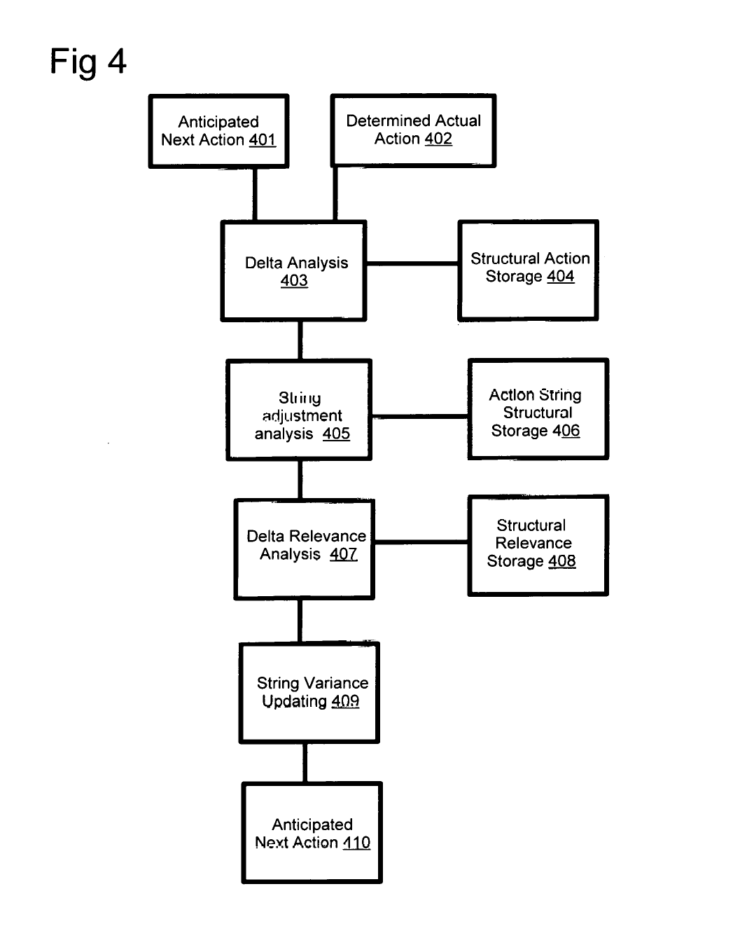

In one embodiment, shown in FIG. 4, an anticipated action 401 and an actual action 402 as determined by the AIS, are analyzed 403 by the system to identify the variances between the two with said variance being algorithmically quantified and compared to stored actions 404 to create an additional and unique set of variance metrics and variables. All metrics and variables are then analyzed 405 to determine the impact or change necessary to existing action stream or action strings 406 to reflect that changed information. AIS methods use these delta values to algorithmically and quickly change the existing action strings or waypoints to reflect the changes between anticipated and actual actions. Variances or delta relevances which represent algorithmic measures and variables of the relevance of changes measures and variables, are analyzed 407, updated and stored in relevance database 408 for use by the AIS in subsequent processing. The AIS continuously uses the variance analysis methods 409 and metrics to update the existing anticipated next action and action strings 410 in real time. Structured numerical data forms a complete representation of action strings and action objects and permits the AIS to use algorithms to change the instantiated objects that represent an anticipated action including identifying which action or action string of all available actions or action strings is the most likely to occur.

For example, a target entity that has a medical condition may be wearing an autonomous safety system and assistive exoskeleton while out for a walk. If the individual suddenly stops on their walk and begins to fall forward, the AIS can provide the safety system with an indication of the risk and threat level of the fall by analyzing the spatial relationship of the target entity and the velocity and type of movement. If the individual is actually falling, the system would be able to differentiate that movement from a movement related to an individual stopping and bending over and would send an indication of a fall to the exoskeleton causing it to stiffen and hold the individual upright. The difference comes in the analysis by the system of variables and metrics related to the target entities movements against anticipated actions and a database of anticipated action variables related to walking and falling vs walking, stopping and bending down to tie a shoelace, view a flower or pet a dog. The delta or variance between an anticipated action and an actual action and the numerical representation of such change within the AIS is the primary mechanism, but not the only mechanism, that the AIS uses to evaluated the impact that such a variance will have on the target entity. In the elderly, this type of system will provide a significant reduction in injuries from falls while allowing them increased mobility and an improved life when combined with external control systems within exoskeleton technology.

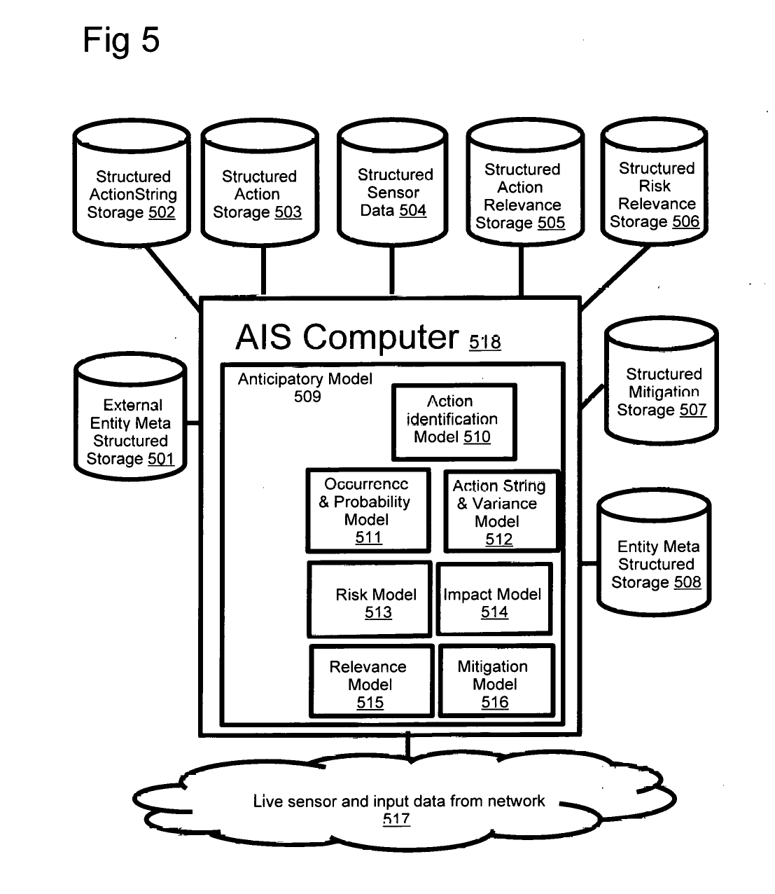

One embodiment of a system configured to implement AIS 509 is shown in FIG. 5 whereby input information is implemented by the AIS objects and methods 517 to identify changes to the input data significant enough to impact the current AIS anticipated action or string of actions. In some instances, but not all, the AIS will compare the input data to pre-existing stored information using a digital serialization methods that convert specific sets and categories of data into structured numerical serial numbers. The system can algorithmically create and interpret the serialized information at an exceptionally high rate of speed allowing the AIS to process large volumes of real time data. In the first instance, the AIS will interpret incoming data from interfaced sensors and systems against pre existing entity information 501, identified actions 503 and action strings 502 and previous sensor data 504 to identify or validate the existing input data within an action and data identification model 510. The system uses the outputs of the analysis methods to instantiate relevance objects and methods that match algorithmic patterns of input information and associated nearby entities and actions with known existing patterns. The resulting impact information forms the basis of determining the relevance 515 of the change to the existing anticipated action and anticipated action strings 512. The information also is input into objects and methods used to determine and calculate impact variables that identify the impact that the input data has on the existing anticipated action or anticipated action strings 514. This information is input into objects and methods that determine the risk 513 of the change on the anticipated action or anticipated action strings and its likelihood of occurrence 511. Output information and data from these objects may be used to update existing storage repositories of action information 505, risk information 506 and entity information 508. The output information is also used to identify mitigation responses from structured mitigation storage 507 for use in mitigation algorithms and methods 516 to produce risk avoidance indications such as warning messages to a smartphone applications or as an input indication into risk response systems such as emergency disaster response systems.

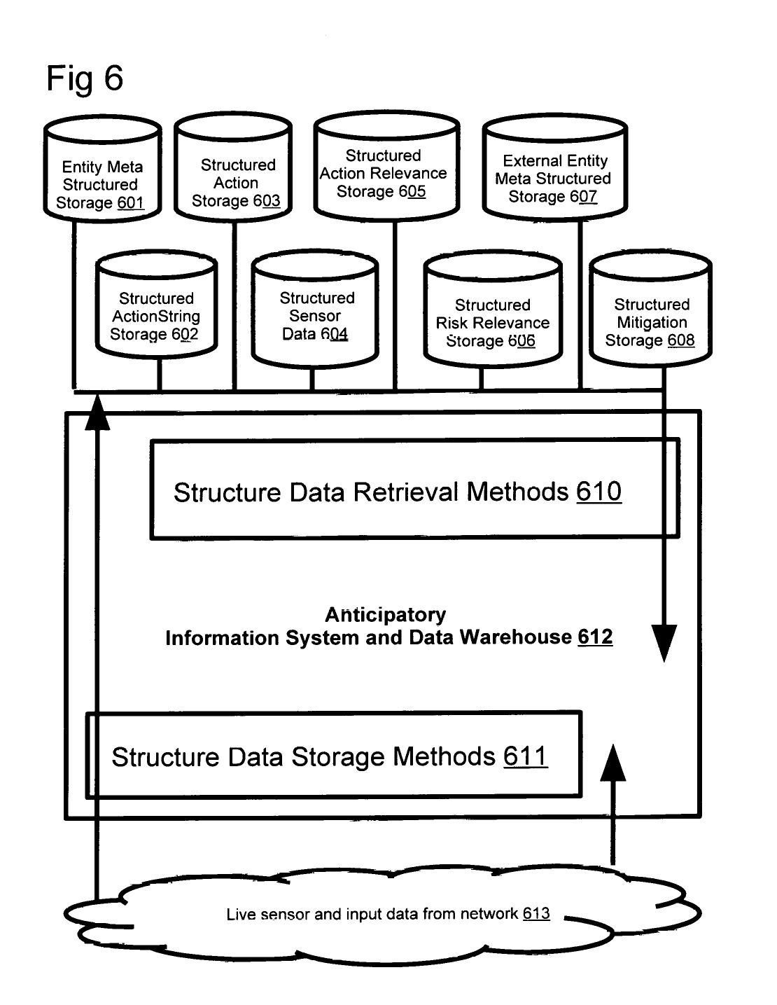

One embodiment of a system configured to implement AIS is shown in FIG. 6 whereby real time information is imported by the AIS and is then altered by appending additional structured algorithmic data prior to storage of data in unique storage structures within one or more databases. The data is then subsequently used by the AIS to rapidly extract relevant information for use by AIS methods in determining an anticipated action or string of anticipated actions. The speed of implementing relevance information via proprietary algorithms gives the AIS its unique ability to constantly self correct and adjust the anticipated action and action strings. For example a sensor input of a ringing phone is interpreted by the AIS as a ringing phone and that information is appended to the meta data provided by the sensory input along with other information such as the source of the call. The AIS can subsequently use the information to alter the probability methods used to determine the delta variance calculation that are applied to the existing anticipatory actions and action strings thereby re-instantiating the current anticipatory action objects related to the current storage actions and action strings to create a new set of current objects. Each new piece of information interfaced to the AIS may or not may not result in a change to anticipated actions or action strings. The AIS may determine that the change is not significant enough, where significance can be identified as an algorithmic measure of, but not exclusively, relevance, impact, trajectory, speed, velocity, position, time, distance, risk, relationship or agreement. Input data received from an external network or system 613 is interfaced into the AIS where it is analyzed against existing data subsets to determine the nature of the data. The analysis results in the appending of additional information to the input data and the storage of the data with one or more structured serialized identification metrics produced by an algorithm and which is then stored in one or more proprietary structured data formats using the serialized data as a key 611 for subsequent use by the AIS. This could include, but is not limited to, data about the entity 601, data related to actions 603 or strings of actions 602, input data 604, action relevance or relationship 605, risk data 606, information about nearby entities 607 or data pertaining to mitigation options 608. Each of these structured data elements are then implemented by the AIS when determining next or anticipated actions or action strings as time progresses 610. Changes or delta variances to this information is implemented by the AIS in complex algorithms to determine the relevance of the change in data to the anticipated action or action strings. In the case of a person watching a TV, a sensory input that detects loud noises coming from the next apartment may be determined by the AIS as not relevant to the actions of the target entity if the noises are common and anticipated. Numerical serialized information appended to sensory input data regarding noise detection including, but not limited to, volume, length, pitch, time, direction or location could be matched to similar serialized input to determine that the noise is expected and of low critical relevance to the future actions of the target entity. However, if the target entity has previously responded to such noises, then the relevance may be significant and the AIS will adjust the probability and risk metrics and use the information to adjust the anticipated next action or action stream based on the previous responses of the target entity and nearby entities.

### AIS Implementation and Model of a Targeted Entity

In a simplistic implementation of an anticipatory information system, an entity is identified as a target entity based on specific characteristics and information unique to that individual such that the target entity is definable by the system and becomes the focus of the system methods. These characteristics and information can include, but are not limited to, name, identification attribute (i.e. unique number), age, sex, height, weight, size, identifying marks, eye color, injuries, behaviors, system identification, location, categorization, classification, pixel attributes, sound attributes (i.e. tone, modulation, pitch), organizational associations or organizational identification.

In one embodiment, the system uses the information about a target entity to instantiate objects and methods that identify the relevance of incoming sensor and system information to the target entity's actions. Nearby entities are also identified by the system using spatial relevance methods and existing entity data. Identified relationships between the target entity and other entities are identified on calculated by the system and stored in analysis objects. The system uses this information to algorithmically evaluate the relevance of the changes in actions of the nearby entities or delta variances and assign risk levels and probabilities of occurrence relevant to the target entity.

Incoming input data streams and existing stored data about the target entity and actions are linked algorithmically via the instantiation of objects and methods and linkage variable are appended to the incoming data and stored with the data if the system has determined that the data is unique or significant enough to warrant storage or as a delta adjustment to the existing data as an update mechanism. For example an increase in an incoming sound detected by input sensors may be determined by the system to be relevant enough, when measured against defined measures and algorithms, to update the existing stored detected sound information but not necessarily as an entirely new stored element. In this case the change in the level or tone of the sound will incrementally update the stored data by the variant or delta as opposed to a brand new sound storage object. This also allows the system to identify patterns of change by recalculation when combined with a time element as opposed to the storage of complete sound data sets. This also allows the AIS to significantly increase the speed with which it detects and analyses change in input data streams.

Additional attribute information about the entity includes, but is not limited to, address of residence, address of employment, type of job, car make, car model, car license plate, cell phone model, cell phone number, home computer type, home computer IP address, work computer type, work computer IP address, layout of home (room indications), construction of home, furniture in home, layout of office, construction of office, furniture in office, layout of office building, construction of office building, layout of apartment building, construction of apartment building, parking spot geolocation office, parking spot geolocation home. This information along with other additional attribute information about the environment of the target entity is also used by the AIS as it analyses input data to determine risk results and potential mitigation actions. Changes in the input data can be algorithmically matched by the system to impact relevance variables that are indicative of the effect that changes to specific input data would have on additional attributes and to the target entity.

For example the system would be able to detect a catastrophic event such as a train derailment of chorine nearby to the target entity and can initiate mitigation actions to affect such additional attributes as shutting automated windows, closing HVAC air intake systems and sending specific alarm notifications with mitigation options to nearby devices. The actions the AIS applies to additional attributes is based on the anticipated break in chlorine cars based on the location of the derailment, age of the tanker cars, amount of chlorine, tank pressure sensor indication, proximity of first responders and the anticipated flow of the chlorine cloud based on nearby wind, temperature and humidity measurements and proximity of other natural environments and man made structures as well as other information.

The system identifies current actions by evaluating the action against known or stored existing actions that the target entity has done including but not exclusively, information pertaining to the type of action, time of the action, duration of the action, frequency of the action, subsequent actions that have been done and action attributes including but not exclusively, speed, velocity, distance and trajectory. Changes and variances in the current action of a target entity are evaluated by the system and anticipated next actions and action strings appropriately adjusted. They are also adjusted by the impact of the actions of other nearby entities and natural systems. Intersections of the anticipated action strings of nearby entities with those of the target entity are analyzed by the system for relevance and threat to the target entity and can result in indications from the system to other nearby entities. For example, a target entity that is detected to have been in a series of successively violent encounters with neighbors and who appears to be performing escalating actions including the purchase and loading of weapons, can result in an indication to nearby entities to stay indoors and lock their doors as the threat level of the target entity's anticipated actions and anticipated action streams increases the threat level of the intersections of the target entities anticipated action streams with those of the anticipated action and anticipated action strings of nearby entities. By measuring action attributes such as the speed and velocity of related actions, as detected and measured by input device data, such as increasing frequency of angry encounters, the purchasing of a weapon, the purchasing of ammunition and angry online discourses, the system algorithmically adapts and adjusts threat levels held within the system's storage (both in memory and in database structures) and evaluates the threat levels against defined and stored threat measures and applies those measures algorithmically to the target entity's anticipated action to determine when a response indication is required based on the anticipated action of the individual. For example, the detection of an individual rapidly getting dressed, loading a new gun and moving to a door after posting an angry note to social media might be identified by the AIS as significant enough of a threat to send indications to nearby entities, associated entities (i.e those associated to the target entity) or emergency response organizations.

An existing current action is updated by the system with each new change in inputs. The relationships between information pertaining to all actions is contained in unique data structures whereby the index information is structured such that the numerical reference is serialized with components of the number becoming elements in other indices. This creates multidimensional indices each containing one or more serialized index reference points. The structure of these serialized indices are unique and provide the system with an exceptionally fast ability to analyze data. The system creates such indices when data is interfaced to the system from other systems and sensors. The system steps through a process of data identification against existing stored reference data, analysis of the exchanges in the data or the delta between existing measures and newly measured indications such as, but not limited to, light, motion, size, scale, speed, velocity, density, color, geometry, time, spatial location, motion, structure, composition, volume, depth, pitch, frequency, motion path, direction, articulation, temperature, humidity, odor and pressure. Changes or deltas are evaluated by the system for relevance and indices are update to reflect either a change or the delta. The system uses the new information to constantly adjust its current anticipated next action for a target entity. The AIS for example may determine that the next anticipated action for an individual is the same action that the target entity is currently doing. As the target entity is detected to move, the AIS updates the next anticipated action of the target entity to be different based on the input data from the input device recording the movement. In the case of an individual with a stroke condition, the input device may be a motion detection device and the anticipated action may be specific movements. As the individual fails to move in the anticipated manner, the AIS can determine if the delta between the anticipated movement and the actual movements are such as to increase the threat level that the individual is having a stroke. For example, rapid movement by the target entity outside anticipated thresholds may be indicative of a seizure and cause the system to interpret the motion against stored risk and threat thresholds as outside the acceptable range resulting in an event indication. The event indication can then send a notification to a device of a care giver indicating a potential anomaly between the anticipated action or anticipated action strings and the current input data.

In one embodiment, the system uses analysis methods to identify an increasing threat level based on continuous analysis of new input data and the impact of that data on an anticipated action or anticipated action string of a target entity. The AIS first identifies if the change in an anticipated action or anticipated action string is algorithmically significant enough to instantiate objects and methods used to identify threats. Threats are contained in a series of structured databases and are linked via complex indices to types of actions. For example the loading of a weapon such as a gun is considered by the system a high threat level activity. The degree of threat is variant on other information such that the action of a hunter loading a weapon as they begin a hunt would be considered of a lower threat level than an individual loading an unregistered handgun shortly after a neighborly dispute. The linkage may take the form of linking the threat from the action of loading a weapon in context with action types that indicate agitation or confrontation or violence as opposed to recreation. Each attribute is serialized in complex index structures that help create a path of digital information for the system to rapidly analyze using algorithms. This includes information that is used in objects and methods to link seemingly disparate information and data together algorithmically through relevance.

The type of threat detected from changes to anticipated actions or anticipated action strings is calculated by the system by comparing structured index data to the index data stored in a reference database of threats. For each action type there will be a number of potential threats determined as resulting from or impacting the action and a relevance linkage to link other threats or to modify threat attributes and variables based on other input data, existing action and entity information. The determination of threats by the system involves both an analysis of changes to the anticipated action or anticipated action strings and the relationship to various types of threats. Threat data is contained within one or more structured databases along with data and variables pertaining to the relevance of associated actions and the identified threat, the risk level of the threat and variables used to determine the severity of the threat on the anticipated action and anticipated action strings.

The threat structured index data is used by the AIS to identity available threat mitigation actions stored in structured databases that can be used by the target entity or nearby entities to reduce the impact of a detected threat. Mitigation action indications are delivered to the systems application interface and can be imported by other systems for notification purposes including but not limited to emergency response systems or smartphone applications. An example of the system implementing mitigation indications is when a change in an action is initiated by autonomous driving or flying systems. An example is a bus that is traveling down a street that pulls to the side of the road and brakes as a result of the detection by the system of a nearby vehicle driving an excessive speed and erratically toward an intersection in front of the bus. The indication can be transmitted in real time to a driver information system on the bus indicating that the driver should pull the bus to the side and wait. In analyzing input data near the bus, the AIS interprets changes detected in traffic camera video to identify a vehicle driving at an excessively high rate of speed, moving erratically and in the correct direction and trajectory as the bus and away from a spike in police system geo indications of a nearby crime (traveling away from the scene of a reported crime at a high rate of speed and with an erratic trajectory). The system uses algorithm methods and unique numerical data structures and indices to identify the action of the target entity (the bus driver), the actions of nearby entities (the individuals driving the car erratically), additional nearby action information (police system information), and the anticipated actions strings of both the target entity (waypoints of travel of the bus) and those of nearby entities (waypoint of travel by the erratically driven car), evaluates the threat level of an erratically driven car coupled with the additional information such as the intersection of anticipated action strings, calculates probabilities of occurrence and factors of relevance. The system then calculates the variance of a mitigation requirement level against threat level thresholds and if outside an acceptable range, applies algorithms to select a best mitigation option (the highest success value) and produces an indication event and an associated mitigation event for interface to other systems. External systems communicate both the threat to the bus (impending collision) and the best mitigation action (pull over and stop).

In another embodiment of the system, the system uses detected information from sensors surrounding a target entity to adjust stored information about actions to improve the detection of future actions. Variance between an anticipated action and an actual action is indicative of a change in the activity of a target individual from what the system anticipated. This variation also extends through anticipated action streams. For example, a target entity walking down a particular street on their way to work may be anticipated by the system to turn right at an intersection to move toward their place of employment. The system maintains information in numerical structures or indices that indicates a probabilities of occurrence for each anticipated action and subsequent anticipated action strings. A change to the anticipated pattern is recorded and stored as a delta variant. If the individual on their way to work turns left instead of right, the system will note the anomalous information and adjust the anticipated action and anticipated action string accordingly. The impact of such a change is captured numerically by the system and it uses the new information to adjust the anticipated actions of the individual. The system uses other attribute information about subsequent actions to the change to determine the relevance of the change. The turn left could have been so the individual can attend a periodic appointment. That appointment action would be subsequently stored by the AIS and be implemented to adjust all future anticipated actions determinations. In this way, the Anticipatory Information System is continuously improving its anticipation results through continuously changing and updated stored data.

In another embodiment, the system combines the elements previously describe to indicate the next anticipated action of a target individual and then uses input sensor information from other systems and information stored by the AIS to detect the actual next action and the variance between the two. These variances, along with other information about the entity and the entities actions, nearby entities and the actions of nearby entities and natural events as detected by other systems or from information derived from or stored by the AIS are used to adjust the next anticipated action and subsequent action streams of the target entity. The system converts existing data into numerical structures, values and variables to apply algorithms designed exclusively to emulate the human brain as it processes risk in the evaluation of actions and in its response to subsequent actions. An extensive amount of time and research into how this human risk mechanism functions in the human brain was performed by the applicant prior to the development of the system and is not part of any current organization or institutional research.

All elements, data and variables within the system are, ultimately, but not exclusively, stored in numerical proprietary structures and arrays unique to the purpose of anticipating the actions of entities and natural events and are not presently used in any known system. The proprietary algorithms used to calculate the output from the AIS as described have not previously been used in any system or described in any publication prior to this application. The concepts described above have not been used or published prior to this application by any other person or group. Although the system includes interfaces to accept input from other systems such as sensors, these external systems do not form part of this application. As well, the AIS includes interfaces to export information for use by other systems and these other external systems do not form part of this application. The application seeks to protect the unique principles, structures and methods noted above as they related to anticipating the actions of biological and natural systems and machine erudition to improve the anticipation result and to use this information to provide an indication of risk level and threat from the action to the target entity and other nearby entities to save lives and reduce injuries from human activity and natural events.

What is claimed is:

1. A system and methods, comprising:
performing, by one or more computing devices:
determining the upcoming actions of an individual (target entity) based on a unique analysis of stored information about the target entity's actions and the actions and activities of other nearby entities or other entities or natural actions or events based on an analysis of stored information about such actions (analysis of actions) that would affect the target entity's actions or natural event and that is stored with additional information and variables including numerical representations of textual data and categorization unique to the anticipation analysis process methods, wherein the system uses such information and additional information about all actions to anticipate and produce the next anticipated actions of a target entity or natural event and a probability of occurrence for each action, and wherein the action of the target entity is stored using methods to improve the accuracy of the next anticipated action and wherein the anticipated action or event is stored along with the actual results including information and variables unique to the anticipation analysis methods and wherein natural event information and data are stored with information and variables unique to the anticipation analysis methods.

2. The method as recited in claim 1, wherein determining the upcoming action of a target entity (individual) comprises the analysis of a target entity's past actions and the actions of other entities that would impact the target entity's future actions (action of other entities) or the target entity's reaction to a unknown occurring natural event.

3. The method as recited in claim 1, wherein determining the upcoming natural event comprises the analysis of past natural events that would impact the future natural events or reaction to a natural event by an individual or target entity as recorded by external sensors input data.

4. The method as recited in claim 1, wherein the information of prior actions and natural events are stored in a database with additional information and variables unique to the methods used to analyze the information for the purposes of determining the target entity's next action and series of next sequential actions including numerical representations of textual data and categorization.

5. The method as recited in claim 1, wherein the actions of a target entity is analyzed using stored information of a target entity's actions, natural events and the actions of other entities to determine and assign impact variables that define the level of risk and probability of occurrence of each action or event and wherein such information is stored with additional information and variables unique to the analysis and determination of a next anticipated action or series of sequential actions (action stream or action string).

6. The method as recited in claim 1, wherein the anticipated actions of a target entity or the anticipated actions of other entities or natural events that would impact a target entity are stored with additional information and variables unique to the analysis of actions including numerical representations of textual data and categorization.

7. The method as recited in claim 1, wherein probability of occurrence variables of a target entity's anticipated actions or the actions of other entities or natural events that would impact a target entity are assigned to each potential action and which variables comprise one or more of the additional information and variables unique to the analysis of actions.

8. The method as recited in claim 1, wherein the actions of a target entity, natural events and the actions of other entities are assigned a variable to identify the priority of the information about the action and a method to change the priority variable and which variables comprise one or more of the additional information and variables unique to the analysis of actions.

9. The method as recited in claim 1, wherein specific meta data is assigned to each action that defines a structure of the relationship of actions to one another and wherein relationship variables are assigned and which variables comprise some of the additional information and variables unique to the analysis of actions.

10. The method as recited in claim 1, wherein input data sets of actions are compared to expected actions and variance variables are determined and stored with action information and which variables comprise one or more additional information attributes and variables unique to the algorithmic analysis of anticipated actions.

11. The method as recited in claim 1, wherein specific meta data is assigned to each variance that defines a structure of the relationship of variances to one another and wherein relationship variables are assigned and which variables comprise some but not all of the additional information and variables unique to the analysis of anticipated actions.

12. The method as recited in claim 1, wherein the relationship of variances between actual actions and anticipated actions of a target entity, natural events and the anticipated actions of other entities are assigned a variable to identify the priority of the information about the relationship of variances and a method to change the priority variable and which variable comprises one or more of the additional information and variables unique to the analysis of anticipated actions.

13. The method as recited in claim 1, wherein a volatility variable of a target entity's actions or the actions of other entities or natural events that would impact a target entity are assigned to each action and which variable comprises one or more of the additional information and variables unique to the analysis of anticipated actions.

14. The method as recited in claim 1, wherein an action is categorized into one or more categories and which categories comprise one or more of the additional information and variables unique to the analysis of actions.

15. The method as recited in claim 1, wherein an action's categories are assigned one or more variables to identify the priority of the information about the category and a method to change the priority variables and which variables comprise one or more of the additional information and variables unique to the analysis of actions.

16. The method as recited in claim 1, wherein an action's categories are assigned one or more variables to identify the relationship between categories and a method to analyze the relationship between categories.

17. A system, comprising:
a data warehouse configured to store variables and information related to a target entity's actions, the actions of other entities that would impact the target entity and natural event information that would impact the target entity; and a computer system configured to access said action variables and information stored on said data warehouse, wherein said computer system is further configured to: determine and assign one or more categories to a target entity's current actions or natural event and its priority based on a comparison of stored actions, events, categories, category relationships and to identify and store any variance between the meta data, variables or information about the action and current stored information of actions as variables and information.

18. The system as recited in claim 17, wherein said computer system determining the category, priority and variance to stored actions or events, analyzes the action or event, the action of other entities and other natural event information to anticipate the next action of the target entity or natural event and calculate one or more priority variables of that action.

19. The system as recited in claim 17, wherein said computer system stores information of new actions by the target entity, by other entities whose actions would impact the target entity, natural event information or other system supplied information with additional meta information and variables unique to the analysis of actions as performed by the system.

20. The system as recited in claim 17, wherein said computer system determines a level of volatility and velocity in the actions of the target entity or the actions of others or natural events or systems that would impact the target entity or natural event and which the system uses such information to calculate one or more priority variables assigned to the next action or event.

21. The system as recited in claim 17, wherein said computer system analyzes the information about a target entity's actions, the actions of other entities that would impact the target entity, natural event information and information supplied by other systems and the relationship between such actions and events to determine the next action of the target entity.

22. The system as recited in claim 17, wherein said computer system changes the category or categories or priority of a target entity's current actions or natural event based on an analysis of new actions performed by the target entity, by other entities whose actions would impact the target entity, natural event information or other system supplied information.

23. The system as recited in claim 17, wherein said computer system sends an indication to other systems regarding the priority and information about a target entity's next action or actions or natural events.

24. The system as recited in claim 17, wherein said computer system stores information about the variance between a target entity's current action or natural event and the anticipated action or actions or events for use in the analysis of future actions.

25. A computer-accessible medium comprising program instructions, wherein the program instructions are computer-executable to: determine the category and priority of the current action of a target entity or natural event, to store information about the current action or natural event and the variance to similar action or event information in a stored database, to analyze and determine the velocity and volatility of the target entity's action or natural event to stored known action or event information, to identify the next anticipated action or event options, to identify the next anticipated action or event with the highest probability of occurrence and to formulate an indication of such next action for use by other systems.

26. The computer-accessible medium as recited in claim 25, wherein determining the category and priority of the target entity's action and the actions of other entities that would impact the target entity, natural event information or information from other systems that comprises determining elements and variables that represent elements such as, but not limited to, movement, location, velocity, direction, data, color, pressure, proximity and type of nearby objects, input sensor information about the target entity actions and environment and comparing such information against a database of known information and identifying any variance to such information and using such information to set category and priority variables for the action.

27. The computer-accessible medium as recited in claim 25, wherein storing the category and priority of said target entity actions and the actions of other entities that would impact the target entity, natural event information or information from other systems, that comprises storing elements and variables that represent elements such as, but not limited to, movement, location, velocity, trajectory, direction, data, color, pressure, proximity and type of nearby objects, input sensor information, about the target entity actions and comparing such information against a database of known information and storing any variance to such information and using such stored information to set and store a new category and priority for subsequent actions.

28. The computer-accessible medium as recited in claim 25, wherein analyzing action or event variables comprises determining the status or state of a target entity's current action or natural event.

29. The computer-accessible medium as recited in claim 25, wherein analyzing action or event variables comprises determining the velocity of the target entity's current action or natural event to determine and store current velocity variables.

30. The computer-accessible medium as recited in claim 25, wherein analyzing action or event variables comprises determining the variance of the target entity's action or natural event to anticipated actions or events to determine and store a variance variables.

31. The computer-accessible medium as recited in claim 25, wherein analyzing action or event variables comprises determining the risk probability of the target entity's action or natural event and to determine and store risk probability variables.

32. The computer-accessible medium as recited in claim 25, wherein determining action or event variables comprises determining the risk probability variables of the target entity's action or natural event.

33. The computer-accessible medium as recited in claim 25, wherein determining the target entity's next anticipated action, actions or events comprises determining the action option variables of the target entity's action, actions or natural event and to make such variables available to other systems and devices.
